(19) United States
(12) Patent Application Publication
(10) Pub. No.: US 2012/0086547 A1
(43) Pub. Date: Apr. 12, 2012

(54) INTERFACE SYSTEM FOR WIRELESSLY ACTUATING A RELAY ASSOCIATED WITH A MOVEABLE STRUCTURE AND METHOD FOR USE OF SAME

(75) Inventors: W. Dale Foster, Dallas, TX (US); E. Noel Gouldin, JR., Plano, TX (US); Stuart W. Stevenson, Plano, TX (US)

(73) Assignee: CelAccess Systems, Inc.

(21) Appl. No.: 13/328,063

(22) Filed: Dec. 16, 2011

Related U.S. Application Data
(63) Continuation of application No. 12/195,389, filed on Aug. 20, 2008.
(60) Provisional application No. 60/956,830, filed on Aug. 20, 2007.
(60) Provisional application No. 61/030,884, filed on Feb. 22, 2008.

(51) Int. Cl. G05B 19/00

(52) U.S. Cl. 340/5.7

(57) ABSTRACT

An interface system for wirelessly actuating a relay associated with a moveable structures and method for use of same are disclosed. In one embodiment, a local access device having call box functionality and a server communicate over a wireless network such as cellular network. The interface provided by the local access device and supporting server may furnish one or more mutually exclusive unique access functionalities relating to a database for Wiegand-compatible access devices and routing of calls from the local access device with the call box functionality to an owner who may or may not be located on premises.

### CROSS REFERENCE TO RELATED APPLICATIONS

This application is a continuation of prior U.S. application Ser. No. 12/195,389 filed on Aug. 20, 2008 and entitled “Interface System for Wirelessly Actuating a Relay Associated with a Moveable Structure and Method for Use of Same,” which claims the benefit of U.S. provisional Application No. 60/956,830 filed on Aug. 20, 2007 and entitled “Wireless Call Box System and Keypad Interface,” and U.S. application Ser. No. 12/195,389 also claims the benefit of U.S. provisional Application Ser. No. 61/030,884 filed on Feb. 22, 2008 and entitled “Wireless Wiegand Interface Module,” and each of the above identified nonprovisional and provisional patent applications is hereby incorporated herein by reference in its entirety for all purposes.

### TECHNICAL FIELD OF THE INVENTION

This invention relates, in general, to remote control functions and, in particular, to an interface system for wirelessly actuating a moveable structure and related method that provide access to a property by an access barrier such as a gate.

### BACKGROUND OF THE INVENTION

Property owners and, in particular, commercial and industrial property owners without access to infrastructure occasionally need to allow an individual including a worker or repair personal, for example, access to a property protected by an access barrier such as a gate. Granting access to the property is a challenge when the property is not staffed or, for a residential property, no one is home to receive the individual or available to meet the individual at the property. Previous solutions that provided alternatives to leaving the property unsecured include providing the individual with a key, remote control, or access code. Each of these previous approaches compromised security and/or inconveniences the property owner in some fashion. Additionally, land phone lines, trenching, mounting poles, card readers, short range RF equipment, and phone based exchange systems were required.

Existing solutions, such as that disclosed in application Ser. No. 11/690,779 entitled “System and Method For Wirelessly Actuating a Moveable Structure” and filed on Mar. 23, 2007 in the names of Foster et al. may further be refined with respect to maintaining the database of codes associated with the entry service and managing call routing to the owner. With respect to the former, various access mechanisms including keypads and proximity or swipe readers require the database at a control panel to be regularly maintained. This maintenance has proven awkward. With respect to the latter, many owners of access barriers want the ability to talk to a visitor before granting access. Typically, a call button at a call box trips a phone in the house or other building on the property. Often, however, the owner may not be present and managing the call routing is a cumbersome interaction with the call box. These limitations require attention while implementing a solution that addresses the underlying problems of lack of infrastructure (e.g., land line telephone service) and no line of sight for RF solutions.

### SUMMARY OF THE INVENTION

An interface system for wirelessly actuating a moveable structure and related method are disclosed that provide access to a moveable structure or an access barrier which may be a gate, a door, or other structure, for example, which includes at least one panel which is swung, drawn, raised, or lowered to partially or completely close an entrance or passageway. In one embodiment, a server wirelessly communicates with a local access device associated with the access barrier. The local access device may include a wireless modem and an interface for communicating with a control unit, such as a gate control box that actuates the moveable structure.

The server may employ a Global System for Mobile Communications (GSM)-based protocol, such as General Packet Radio Service (GPRS), Code Division Multiple Access (CDMA) channel access methods (and similar channel access methods), ReFLEX wireless protocol, or a Short Message Service (SMS) protocol or standard, for example, to communicate with the local access device over a wireless telecommunications network or cellular network. It should be appreciated, however, that any cellular or mobile protocol may be utilized. Such a system is compatible with that of application Ser. No. 11/690,779 entitled “System and Method For Wirelessly Actuating a Moveable Structure” and filed on Mar. 23, 2007 in the names of Foster et al.

In one operational embodiment, the interface provided by the local access device and supporting server may furnish one or more unique, mutually exclusive access functionalities relating to Wiegand-compatible access devices and routing of calls from the local access device with the call box functionality to an owner who may or may not be located on premises. With respect to the former, the database associated with the verification of the access code provided by the Wiegand-compatible access device may be located locally with the access device, remotely with the server, or at a third-party control panel. With respect to the latter, the server may manage the routing of a plurality of calls to a plurality of pre-designated telephone numbers associated with the owner of the call box in order to establish a call between the user and the owner.

### BRIEF DESCRIPTION OF THE DRAWINGS

For a more complete understanding of the features and advantages of the present invention, reference is now made to the detailed description of the invention along with the different figures refer to corresponding parts and in which:

FIG. 1A is a schematic diagram of one embodiment of an interface system for wirelessly actuating a relay associated with a moveable structure being employed in a networked environment with multiple properties each having a moveable structure;

FIG. 1B is a schematic diagram depicting the interface system for wirelessly actuating a moveable structure presented in FIG. 1A being utilized with one particular property;

FIG. 1C is another schematic diagram depicting the interface system for wirelessly actuating a moveable structure presented in FIG. 1A being utilized with one particular property;

FIG. 2 is a schematic block diagram depicting one embodiment of a management server;

FIG. 3 is a schematic block diagram depicting one embodiment of a local access device;

FIG. 4 is a flow chart depicting one embodiment of a method for wirelessly actuating a moveable structure with a Wiegand-compatible access device;

FIG. 5 is a flow chart depicting another embodiment of a method for wirelessly actuating a moveable structure with a Wiegand-compatible access device;

FIG. 6 is a flow chart depicting an embodiment of a method for wirelessly actuating a moveable structure using call box functionality; and

FIGS. 7A and 7B together form a flow chart depicting a further embodiment of a method for wirelessly actuating a relay associated with a moveable structure.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

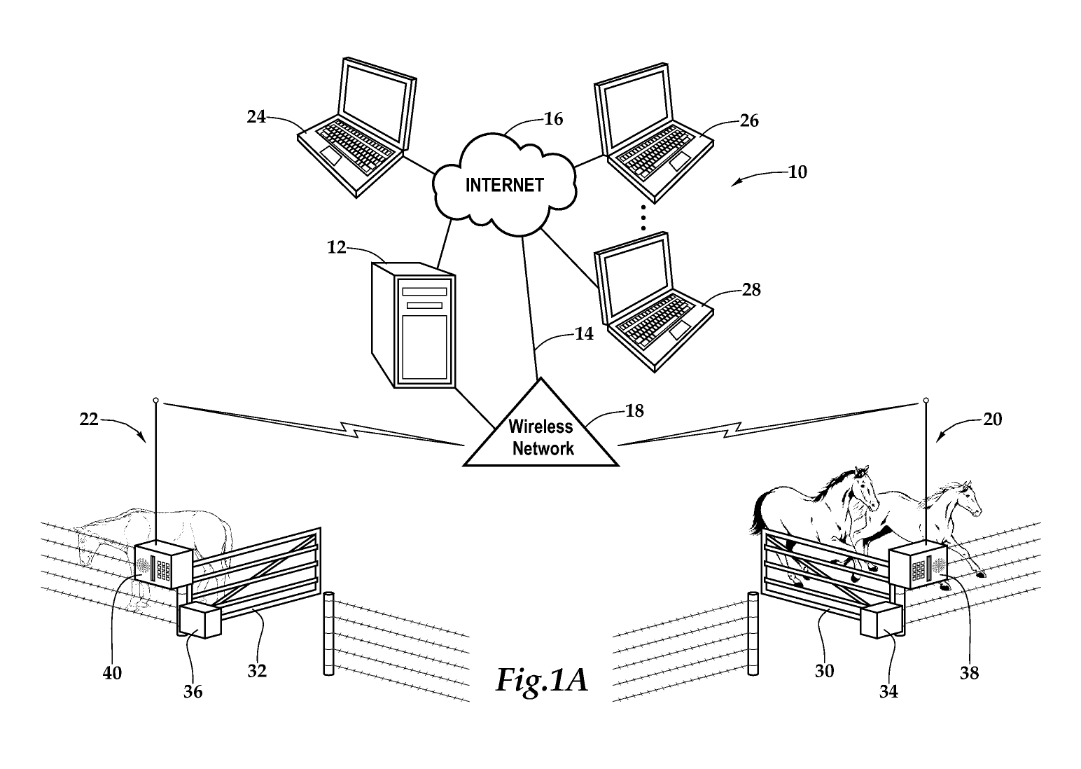

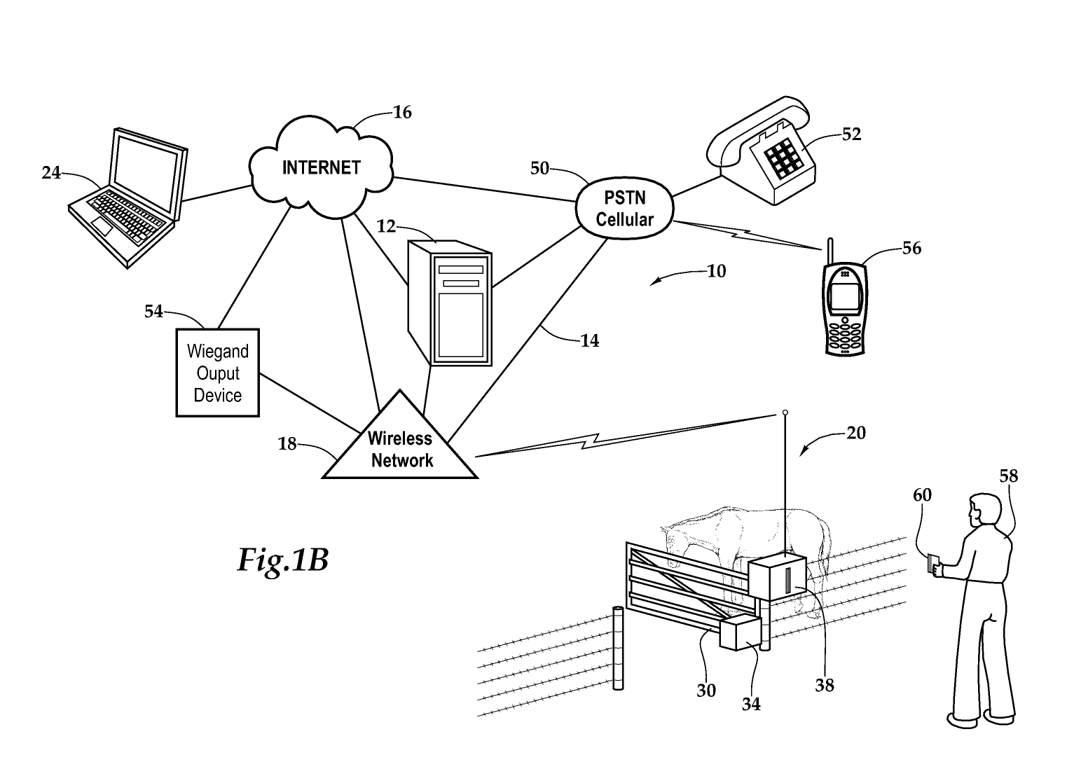

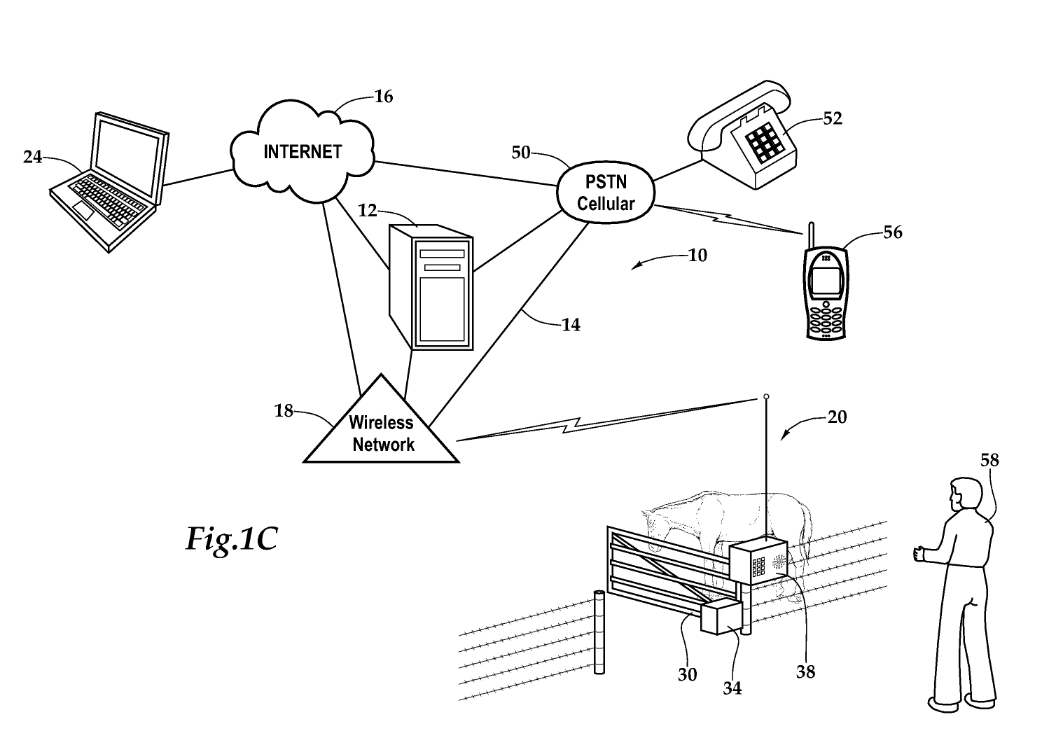

Referring initially to FIG. 1A, therein is depicted an interface system for wirelessly actuating a moveable structure that is schematically illustrated and generally designated 10. The interface system 10 includes a management server 12, which may be referred to as a server 12, being employed in a networked environment 14, as represented by Internet 16 and wireless network 18, with multiple properties 20, 22. Multiple computers 24, 26, 28 are connected to the Internet 16 and may be utilized by system administrators or users, as explained in further detail hereinbelow, to access and maintain the system 10.

Each property 20, 22 respectively includes a moveable structure 30, 32 and control units 34, 36 associated therewith for actuating the moveable structures 30, 32. Local access devices 38, 40 are respectively associated with moveable structures 30, 32 and control units 34, 36 to provide control signals for actuating the moveable structures 30, 32. In operation, as will be explained in further detail in FIG. 1B, the management server 12 in combination with local access devices 38, 40 permits property owners and users to actuate the moveable structures 30, 32 using functionalities relating to the enablement of Wiegand-compatible access devices and the routing of calls from one of the local access devices 38, 40 to an owner who may or may not be located on premises. It should be understood that the owner may include, depending on the situation, an individual selected from the group consisting of a resident, a guest, a designated party, and security personnel, for example. These functionalities of this system and method may be used independently of or as an augmentation of the functionalities of application Ser. No. 11/690,779 entitled “System and Method for Wirelessly Actuating a Moveable Structure” and filed on Mar. 23, 2007 in the names of Foster et al.; which is hereby incorporated by reference for all purposes.

The systems and methods presented herein provide a completely self-contained solution for actuating a moveable structure in any place having wireless network coverage. Land phone lines, trenching, mounting poles, card readers, short range RF equipment, and phone based exchange systems are not required for use of the present system as the system utilizes a wireless network and remote server to maintain and, in certain instances, actuate the moveable structure. Additionally, the systems and methods presented herein provides security without inconveniences to the property owner.

Although the properties 20, 22 are depicted as ranches, it should be appreciated that each property 20, 22 may be any other type of property having any type of barrier or structure. Further, each moveable structure 30, 32 may include any structure having one panel which completes a motion in order to at least partially close an entrance selected. The motion may be being swung, being drawn, being raised, or being lowered, for example. Accordingly, by way of example, a property and moveable structure may include a gate at a ranch, a garage door to a townhouse, or a gate to an estate or home. Moreover, the embodiments discussed herein are equally applicable to commercial and industrial applications and particularly at remote facilities and installations having no staff. By way of example, the solutions of the present invention are particularly well adapted to cell towers, executive airports, oil field installations, self storage facilities, electric transmission substations, vacant real estate properties, and rail yards.

Further, the teachings presented herein, as will be illustrated in further detail hereinbelow, may be utilized with locking mechanisms that may or may not be associated with moveable structures. Locking mechanisms include mechanical devices, such as locks and keys, electromechanical devices such as access card systems, magnetic locks, and solenoid bolts, for example. In this implementation, the server and local access device presented herein effect the state of locking mechanism, by for example, transitioning the state from locked to unlocked. This embodiment is substantially similar to the embodiment for actuating a moveable structure, however, the local access device is coupled to a control unit for a locking mechanism as opposed to a control unit for a moveable structure. It should therefore be appreciated that the systems and methods presented herein may be utilized with any type of relay device having a first and second state and a transition therebetween. Moreover, variations are possible including the at least partial integration of the control unit and local access device.

FIG. 1B depicts the system 10 for wirelessly actuating the moveable structure 30 presented in FIG. 1A being utilized with the property 20. As illustrated, the networked environment includes a PSTN 50 that connects a land line 52 to the management server 12. It should be appreciated that although the network 18 is depicted as supplying service via PSTN 50, other network supply services are within the teachings presented herein. By way of example, a Plain Old Telephone Service (POTS), cell phone, high-speed cable-based system, satellite-based systems, or other phone system providing local and long distance interconnectivity may be utilized as well. Similarly, it should be appreciated that the wireless network 18 represents a diverse possibility of networks including cellular networks, Internet-based networks, satellite-based networks.

A Wiegand output device 54, which will be discussed later, is connected to the management server 12 by the wireless network 18 or the Internet 16 and in communication with third-party legacy technology (not shown). A cellular device 56 is located in communication with the cellular network 50, which may be a cellular network. A user 58 having an access device 60, such as an keycard, is at the property 20 and wanting to the gain access to the property by way of the moveable structure 30. As previously alluded to, the user 58 utilizes the access device 60 to gain access to the property 20 by actuating the access barrier 30 in one of two ways, depending on the configuration of the local access device 38 being deployed. It will be noted that in this particular embodiment of the local access device 38, only a Wiegand-compatible access device is depicted and the call box functionality is not depicted.

In one embodiment, the management server 12 is utilized for authenticating and verifying the access code provided by the access device 60. In this implementation, the local access device 38 relays the access information to the server 12 via the wireless network 18. The server 12, in response, sends a reply by way of the wireless network 18 to indicate if the access code is accepted or declined. If accepted, the local access device sends a control signal to the control unit 34 to actuate the moveable structure 30 from the closed position to the open position, thereby permitting the user 58 to enter. The control unit 34 associated with the moveable structure 30 actuates the moveable structure 30 from a first position to a second position in response to receiving a control signal. The local access device 38, which is electromechanically coupled to the control unit 34 and disposed in wireless communication with the cellular network 18, upon receiving the control signal from the management server 12, forwards the control signal to the control unit 34. The control signal received by the local access device and sent to the control unit 34 may be the same control signal or a modified control signal. Additionally, depending on the command, such as hold open (e.g., open for 5 minutes, then close), a control signal may comprise more than one signal sent to the control unit 34.

In a second embodiment, the server uses the wireless network 18 to periodically update access code information stored at the local access device 38. In this manner, the local access device 18 verifies the access code without the immediate use of the wireless network 18. The authentication and validation occurs at a local device level. As with the other embodiment, if the access code is accepted, then a control signal is sent to the control unit 34 to actuate the moveable structure 30. If the access code is not accepted, then the moveable structure 30 is not actuated and remains closed. In this implementation, wireless connectivity is not required at the time of the entry request. The local access device 38 may record the activity for eventual upload to a log stored at the management server 12 at a time convenient to wireless coverage.

FIG. 1C illustrates another embodiment of the interface system providing access by the user 58 to the property 20. In this embodiment, the user 58 does not have an access device or access code to gain entry. Rather, the local access device 38 furnishes the user 58 with a call box functionality. It will be appreciated that compared to FIG. 1B, the embodiment of the local access device 38 in FIG. 1C has only the call box functionality without the Wiegand-compatible access device. It will be further noted that the call box embodiment of FIG. 1A includes both the functionalities of FIGS. 1B and 1C. This emphasizes that the components and teachings presented herein may be used in different manners depending on the required circumstances. The user 58 calls the owner of the property 20. The call is handled by the management server 12 that maintains a list of telephone numbers to reach the owner. The management server 12, simultaneously or sequentially, calls the telephone numbers associated with the owner. In the illustrated embodiment, these designated numbers include the telephone number for the telephone 52 and the telephone number for the cellular device 56. The connection that the owner answers is maintained and any other connections are disconnected. The management server 12 then establishes a communication channel between the phone of the owner, such as cellular device 56, and the local access device 38 to permit communication. The owner at any time during the conversation may instruct the local access device, by a voice command or a button command, to open the moveable structure 30 for the user 58 or to deny access to the property 20.

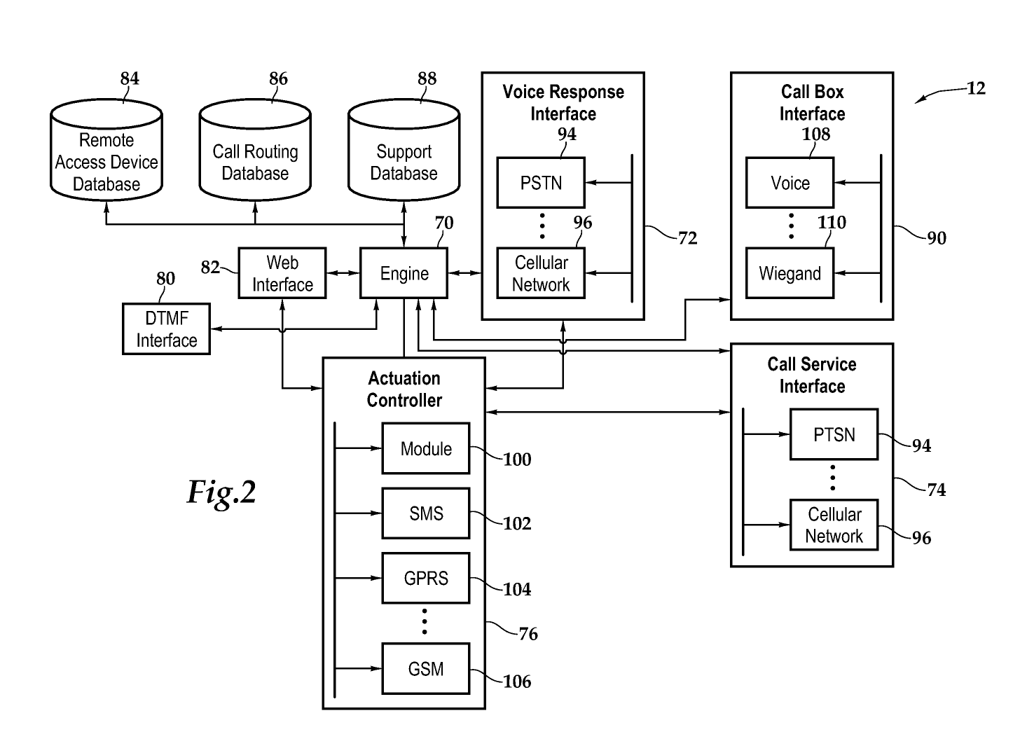

FIG. 2 depicts one embodiment of a management server 12, which includes an engine 70 and connected thereto a voice response interface 72, a call service interface 74, an actuation controller 76, a DTMF interface 80, a web interface 82, several databases including a remote access device database 84, a call routing database 86, and a support database 88, and a call box interface 90. The engine 70 includes the software, hardware, and firmware necessary to drive the functionality of the management server 12, which includes moveable structure actuation and management services to owner and administrators via the Internet 16, PSTN/cellular network 50, and other network architectures. The voice response interface 72 is a computerized subsystem of the management server 12 that allows a person, such as a telephone caller or cell phone user, to select options from a voice menu and otherwise interact with the computer phone system.

In one implementation, voice response interface includes an Interactive Voice Response (IVR) system that plays a pre-recorded voice prompt and directs a party to press a number on a telephone keypad to select or designate an option. For example, “please enter the gate number followed by the pound sign” or “press 1 for open and immediately close, press 2 for open and hold open” or press “54 for the Smith residence”. In other implementations, the voice response interface may recognize the caller's simple spoken answer such as “yes”, “no”, or a number as a valid response to the voice prompt. The voice response interface may use Dual Tone Multi-Frequency (DTMF) signals (generated by interaction with the telephone keypad), natural language speech recognition, and other IVR technology to interpret the caller's response to prompts. The management server 12 may interface with either the cellular network 18 or the PSTN 50 as represented by the functionality modules 94, 96. It should be appreciated that although one particular architecture is presented for the management server, the management server may comprise any combination of hardware, software, and firmware.

The call service interface 74 provides automatic telephone dialing and circuit switch call support to establish communication between any two points such as the local access device and a telephone, mobile phone, or pager, for example. In operation, the call service interface 74 may access call routing records for a particular owner in the call routing database 86 and the owner's designated telephone numbers. The call service interface 74 then proceeds to call the designated telephone numbers to locate the owner and establish a call between the owner and the user located at the local access device 38.

The actuation controller 76 is a computerized subsystem of the management server 12 that controls the signaling sent to the local access devices 38, 40. In order to interface with the local access devices 38, 40, the actuation controller 74 includes protocol modules, such as protocol module 84, SMS module 86 and GPRS module 88. It should be appreciated that the management server 12 including the actuation controller 84 may utilize any type of cellular protocol to communicate with the local access devices 38, 40. As depicted, GPRS and SMS are presented. GPRS is used as a data services upgrade to any GSM network. It allows GSM networks to be truly compatible with the Internet by employing a packet-mode technique to transfer data traffic in an efficient manner. SMS is used to transfer text messages over mobile networks between a GMS Public Land Mobile Network (PLMN) mobile station and a short message entity via a service center. As previously discussed, other protocols including, for example, ReFlex, paging-based protocols, satellite, CDMA, and combinations thereof may be implemented as well.

The DTMF interface 80 provides DTMF generation and repeating as a function to augment the actuation controller 76. In instances where the management server 12 has facilitated a connection between the owner and the user, the owner may press a particular button to provide a command signal that the owner wants to actuate the moveable structure 30 and provide access. The DTMF interface 80 receives this command signal and generates a control signal that is sent one or multiple times to the local access device 38. In one embodiment, the command signal is simply a button such as “*” that indicates the owner's desire to grant access. The control signal, on the other hand, may be a much more complicated DTMF-generated or data signal that is local access device specific and created after the management server 12 references a database such as the support database 88.

The web interface 82 accepts input from users and provides output to users by generating webpages which are transported via the Internet 16 and viewed by the user using a web browser program on the computer 24, for example. In one implementation, the web interface 82 utilizes a series of menus and websites to provide substantially realtime control and administrative functions related to the moveable structures. By way of example, the web interface 76 may provide account setup, creation of access codes, creation of temporary access codes, creation of access codes having restrictions for date ranges, time of entry, number of entries as well as reporting on use. Additionally, the web interface 82 may include a unique homepage for each user that specifies the current status of each gate and other related information in an environment having a user-friendly graphical interface. Further, it should be appreciated that the access and control privileges may vary between the users and administrators.

The web interface 82 also permits an owner or administrator to create customizable access policies that are enforceable based on location, property, time of day, duration, or other events with all of this data, including successful and unsuccessful attempts to gain access to a particular property or resource, being logged. Such access may operate off a common list or table of attributes and policies, or separate lists or tables of attributes and policies. Such information may form a portion of the support database 88.

The support database 88, similar to the remote access device database, may comprise a structured collection of records or data which is stored such that the applications and programs embedded in the management server 12 use a query language for access and consultation. By way of further example, Automatic Number Identification (ANI) functionality may be enabled by the database 78.

The call box interface 90 interacts with the local access device upon a call being placed by the local access device therewith. In one implementation, the call box interface 90 identifies the local access device based upon the ANI. A voice module 108 and a Wiegand module 110 support the voice and data communications originating from the local access device. The remote access device database 84 provides the reference source for verifying access information received as well as the periodic updates of access information stored at the local access device.

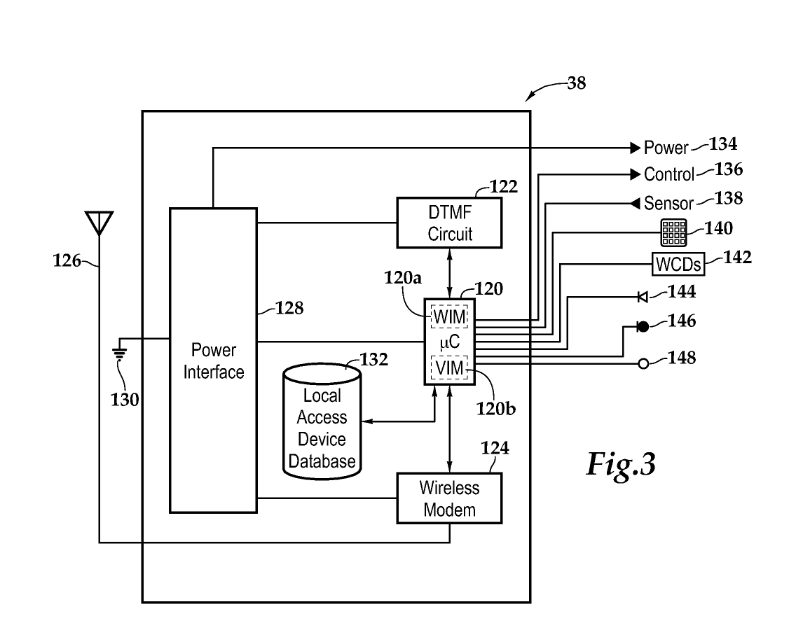

FIG. 3 depicts one embodiment of a local access device 38 which may interface with a standard or conventional control unit, such as a gate control unit. A microcontroller 120 controls the local access device 38 and provisions the interface with the wireless network in combination with a Wiegand Interface Module (WIM) 120a and a Voice Interface Module (VIM) 120b; both of which may be OEM or aftermarket offerings. Further, the WIM 120a and VIM 120b are not limited to interfacing with the microcontroller 120. One or both may interface with any type of control panel in a local access device, a door panel, a wireless modem, or further downstream in communication with an existing ISP. More specifically, the microcontroller 120 contains all the processing, memory, and interfaces needed for supporting the relaying functionalities of the local access device and actuation of moveable structure through the control unit. Four components are connected to the microcontroller; namely, a DTMF circuit 122, a wireless modem 124 connected to an antenna 126, and a power interface 128. The wireless modem 124 uses the antenna 126 to form a wireless access point connecting the local access controller 38 to the management server 12 via the wireless network 18. In one implementation, the wireless modem 124 may be considered a gateway to the control unit 18 that provides for the exchange of data.

The power interface 128 distributes power to the microcontroller 120 and the wireless modem 124. A power connection 134 receives power from the control unit 34 and a ground connection 130 is appropriately grounded. The power interface 128 may be used with both 12 and 24 volt DC systems or AC systems. In this implementation, power is received from the control unit and control signals are sent to the control unit.

The microcontroller 120 also includes connections to a control connection 136, a sensor detector 138, a keypad 140, Wiegand-compatible device(s) 142, a speaker 144, a microphone 146, and an indicator 148, such as an LED, which provides a cellular signal status light (e.g., “On” or “Off”). The speaker 144 and microphone 146 components may form a portion of the call box functionality of the local access device. In response to the wireless modem 124 receiving a control signal from the management server 12, the signal is relayed to the microcontroller 120 which, in turn, forwards the control signal to the control unit 34 by way of the control connection 136. It should be appreciated that modifications and changes to the architecture of the local access device 38 are within the teachings of the present invention. By way of example, the power interface 128 may be replaced or supplemented with a power source such as a battery or solar power collector. Additionally, by way of further example, components may be combined. The microcontroller 120 and wireless modem 124 may be combined. Moreover, the local access device 38 may be partially or completely integrated with the control unit in particular implementations and OEM offerings.

Additionally, a local access device database 132 is in communication with the WIM 120a. This database 132 being substantially a local version of the remote access device database 84. The keypad or control panel 140, the speaker 144, and the microphone 146 are connected to the microcontroller 120 and may form the call box that may, in particular implementations, allow for pre-assigned access codes which may be entered directly into the call box to gain entry to the property or premises by actuating a moveable structure or effecting a state transition in a locking mechanism. Further, the control panel 140, speaker 144, and microphone 146 enable a visitor to enter data and send and receive audio. The local access device 38 also includes a DTMF circuit 122 for accepting numbers entered by a user at the control panel 140 and implementing associated signaling over the line in the voice-frequency band to the management server 12, which once receiving this signaling, dials the appropriate number to connect the user with the property owner, for example. It should be understood that whether the local access device 38 is utilized to actuate a moveable structure or effect a state transition in a locking mechanism, the local access device may have the components and architecture described hereinabove.

In particular, the local access device 38 may refer to different combinations of components and, as used herein, the local access device 38 may refer to components that are co-located. Further, the teachings presented herein may be employed with only some of the components. As illustrated, FIG. 3 illustrates a local access device with full functionality. As mentioned, however, different combinations of functionalities are within the teachings of the present invention. Further, exemplary implementations of the local access device are presented in Table I.

TABLE I
Component Configurations for the Local Access Device

| | Local Access Device | Local Access Device |
|---|---|---|
| Embodiment | Subcomponent 1 | Subcomponent 2 |
| 1 | WIM 120a | WCD 142 |
| | Wireless Modem 124 | No call box |
| | Antenna 126 | functionality |
| | Power Interface 128 | |
| 2 | WIM 120a | WCD 142 |
| | Wireless Modem 124 | No call box |
| | Antenna 126 | functionality |
| | Power Interface 128 | |
| | Local Access Device | |
| | Augmentation with | |
| | Wiegand output device 54 | |
| | for third-party legacy | |
| | equipment | |
| 3 | WIM 120a | WCD 142 |
| | Wireless Modem 124 | No call box |
| | Local Access Device | functionality |
| | Database 132 | |
| | Antenna 126 | |
| | Power Interface 128 | |
| 4 | VIM 120b | Call box functionality |
| | Wireless Modem 124 | with keypad 140, |
| | Antenna 126 | speaker 144, |
| | Power Interface 128 | microphone 146 |

With respect to each of the embodiments described in Table I, which is an exemplary listing and is not exhaustive, the subcomponents are co-located and/or disposed in communication with each other to form a particular embodiment of the local access device. In particular, the WIM 120a and the VIM 120b are mutually exclusive components that may be combined or used separately in independent embodiments. In operation, the WIM 120a allows any Wiegand-compatible device, whether keycard reader, proximity reader, keypad or other device, to operate anywhere cellular network service is available, without the expense and complexity of a local master control system. The WIM 120a is simply wired directly to the Wiegand device at the electronic door, gate, lock, or other portion of the local access device. Access codes read from Wiegand devices are then received and transmitted via the wireless network 18 to the management server 12, which may function as an automated control center, where access codes set up by the customer and verified. Once verified, the management server 12 sends a command back to the WIM 120a to open a door, gate or lock; all in 3 seconds or less. Additionally, as noted above, the WIM 120a may be used in conjunction with the Wiegand output device 54 to communicate with legacy equipment disposed at a third-party location. This legacy equipment providing the verification instead of a database residing locally at the local access device 38 or the management server 12.

The VIM 120b is a wireless or cellular based telephone entry system that, being a cellular system, requires that no trenches be dug, no hard wired connections to run, no line of sight requirements and no distance limitations. If there is cellular or wireless service available, the VIM 120b can connect anywhere in the world.

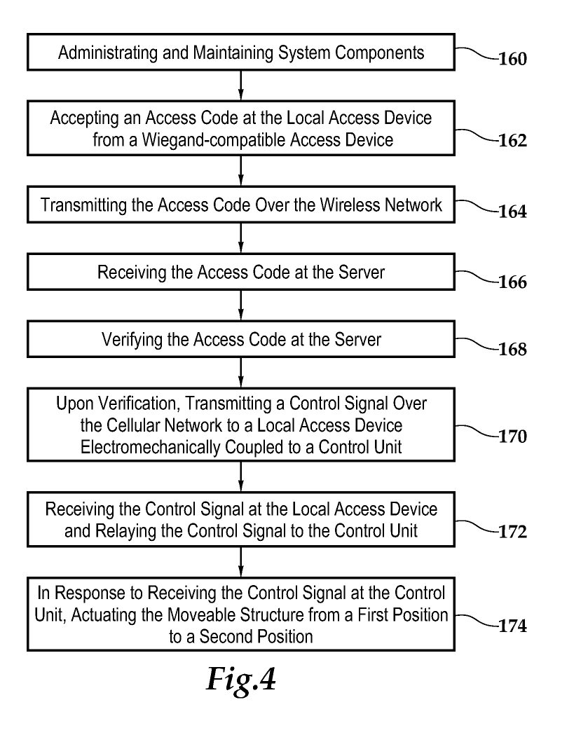

FIG. 4 depicts one embodiment of a method for wirelessly actuating a moveable structure. At block 160, administration and maintenance of the system components occurs. This may include various administrative and logging functions as well as the setup and maintenance of individual accounts. Further, this may include the maintenance of the remote access device database 84 located with the server.

With respect to updates, as the local access device 38 updates its local database with record changes such as the status of a moveable structure (e.g., locked/unlocked), its position (e.g., open/closed), and events (e.g., attempted entry/entry granted) entries are made and the records at the management server are updated. The following table, Table II, presents one embodiment of a protocol used to make such updates.

TABLE II
Exemplary Protocol

| Data Element | Description/Comments |
|---|---|
| Revision ID | A unique, sequential identifier assigned by |
| | the server to ensure each update is |
| | processed in sequence. |
| Update Type | A code indicating if the change is: |
| | Add a new access code record |
| | Change an existing access code record |
| | Delete a current access code record |
| | Clear the entire code database |
| | Batch - multiple entries |
| Access Code | The access code to be added, changed, or |
| | deleted |
| Access Restrictions | A code (or bit string) indicating which |
| | restriction types are active for the subject |
| | access code. The optional restrictions types |
| | are: |
| | Open and Hold Allowed |
| | Restrict by total number of uses |
| | Restrict by date range |
| | Restrict by time range |
| | Restrict by day of week |
| Total uses remaining | Numeric value of total uses remaining (if |
| | restricted by total number of uses). |
| Valid date range | Starting and ending dates within which |
| | range the code is valid (if restricted by date |
| | range). |
| Valid time range | Starting and ending times within which the |
| | code is valid (if restricted by time range). |
| | Note, time ranges can be “looped” such as |
| | 22:00 to 02:00 for 10 P.M. thru 2 A.M. |
| Valid days of the week | A code (or bit string) indicating days of the |
| | week the week on which the code is valid |
| | (if restricted by date of the week). |

In addition, messages initiated by the local access device 38 are utilized to further report access code usage (or attempted usage), input line changes, status reports, or database validation/update requests. These types of reports may include the following data elements shown in Table III.

TABLE III
Report Data Elements

| Data Element | Description/Comments |
|---|---|
| Report ID | A unique, sequential identifier assigned by |
| | the remote device to ensure each report is |
| | processed in sequence. |
| Report Type | A code indicating if the type of report: |
| | Device boot |
| | Device status (or input change) |
| | Failed access |
| | Successful access |
| Report Time/Date | Time and date report was generated |
| Device DB | Serial number of lasted db update |
| Revision Level | processed by the device at time of |
| | transmission, not when report was |
| | generated. |
| RSSI | GSM signal strength indication at time of |
| | report was generated. |
| Input state | Input line(s) state at time report was |
| | generated. |
| Reports lost flag | Indicator if reports were lost due to circular |
| | report buffer overflow. |
| Access Code | The access code entered by the user (access |
| | reports only). |
| Validation Code | A code indicating success or failure of an |
| | access code entry, and failure reason if |
| | failed (access reports only). |

Returning to FIG. 4, at block 162, an access code is accepted at the local access device 38 from a Wiegand-compatible access device 142. The WIM 120a acquires the access code from the Wiegand-compatible access device 142 and using the wireless modem 124 and antenna 126, the access code is transmitted over the wireless network 18 from the local access device 38 to the management server 12 at block 164. The access code is received at the management server 12 at block 166 by the call box interface 90 under the guidance of the engine 70 verifies the access code by referencing the remote access device database 84 located at block 168.

At block 170, upon verification, a control signal is transmitted over the wireless network to the local access device 38 electromechanically coupled to a control unit 34. In one implementation, the control signal is generated by the actuation controller 76 and send to the local access device 38. In response to receiving the control signal at the control unit 34 at block 174, the relay is actuated, thereby actuating the moveable structure 30 from a first position to a second position. It should be appreciated that the control signal sent from the management server 12 to the local access device 38 and the control signal sent from the local access device 38 to the control unit 34 may be identical or different. It should be appreciated that the term control signal is used to indicate an intent, e.g., open or remain closed, rather than specific analog or digital message with a particular formatting and architecture.

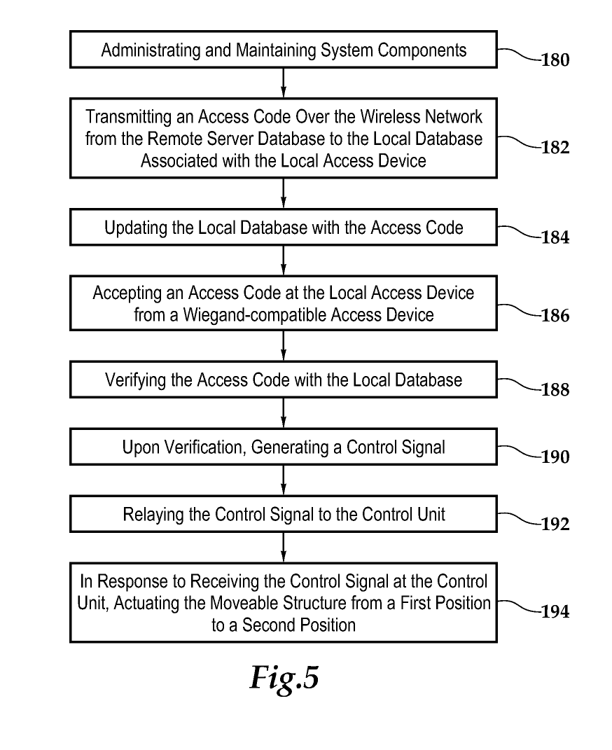

Before moving onto FIG. 5, it should be noted that the teachings presented herein encompass a further alternative for access code verification. Using the Wiegand output device 54, a connection may be established to legacy technology having a legacy control panel or database structure housing information about the access codes. In this configuration, the Wiegand output device 54, as an interface communicating with the legacy technology, enables the access information to be verified at the remote third-party server or legacy control panel, thereby minimizing administrative overhead. The Wiegand output device 54 utilizes the wireless network 18 and/or Internet 16 to establish a channel of communication from the local access device 38 to the management server 12 to a third-party legacy control panel or other legacy structured database containing the access code information. The Wiegand output device 54, being in communication or co-located with the legacy technology in order to create an interface, coordinates and enables the verification of the access code information with the legacy technology without the need for additional administration and by leveraging existing legacy infrastructure. This alternative methodology, with respect to that of FIGS. 4 and 5, represents a third means for utilizing the WIM 102a. Except for the verification step, the this legacy verification methodology using the Wiegand output device 54 is substantially similar to the methodology of FIG. 4.

Accordingly, this third Wiegand-based methodology for verifying access codes begins with an access code being accepted at a local access device 38 from a Wiegand-compatible access device 42. The access code is then transmitted over the wireless network 18 from the WIM 120a to the management serve 120. Once received at the management server 12, the Wiegand output device 54, which is interfacing with a third-party control panel, is utilized to verify the access code at the legacy third-party control panel. Upon verification, a control signal is returned to the management server 12 and then transmitted over the wireless network 18 to the local access device 38 where the control signal is received and the control signal is then relayed or forwarded to the control unit 34 for actuation of the relay.

FIG. 5 depicts one embodiment of a method for wirelessly actuating a moveable structure. At block 180, administration and maintenance of the system components occurs. The administration may be substantially similar to that presented in FIG. 4. At block 182, the management server 12 periodically transmits access codes over the wireless network 18 from the remote access device database 84 at the management server 12 to the WIM 120a; this methodology being an alternative to that discussed under the administrative block 180. The WIM 120a populates and updates the local access device database 84 at block 184 with this information provided by the remote access device database 84. At block 186, an access code is accepted at the local access device 38 from the Wiegand-compatible access device 142. At block 188, the access code is verified by referencing the local access device database 132. Upon verification, a control signal is sent to the control unit at blocks 190 and 192. In response to receiving the control signal at the control unit, the relay is actuated, thereby actuating the moveable structure from a first position to a second position at block 194.

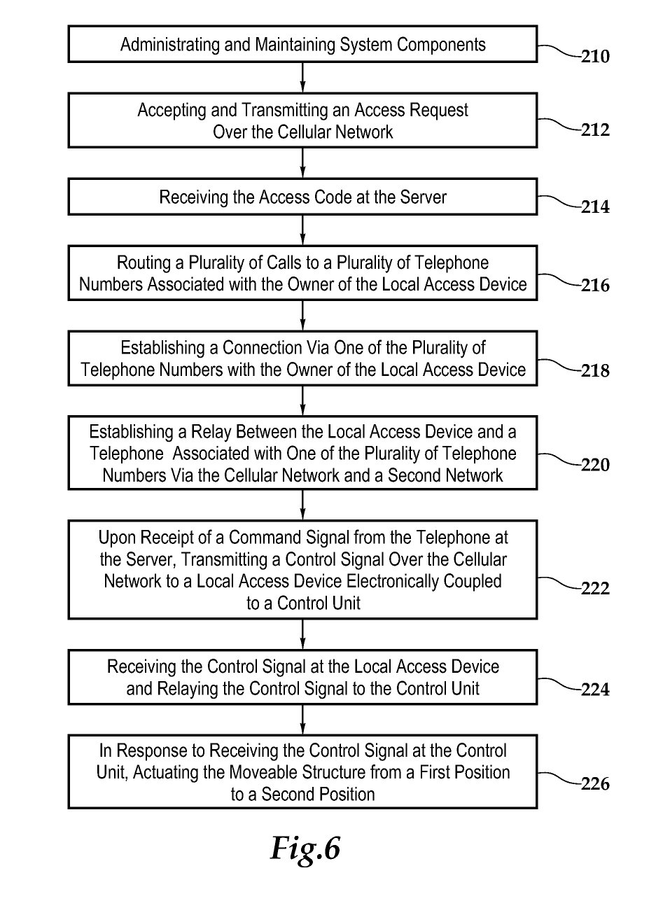

FIG. 6 illustrates one embodiment of a method for wirelessly actuating a moveable structure with a call box. At block 210, administration and maintenance of the system components occurs. At block 212, an access request is accepted at the local access device 38 which includes call box functionality that may be embodied in part by the keypad 140, the speaker 144, and the microphone 146. The access request may be the user pushing a button on the keypad 140. This access request initiates a circuit switch call over the wireless network 18 between the local access device 38 and the management server 12. At block 214, this access code is received at the management server 12 and the management server 12 identifies the call box based on caller identification information. At block 216, a plurality of calls to a plurality of telephone numbers associated with an owner of the property are routed. At block 218, a connection is established via one of the plurality of telephone numbers with the owner. At block 220, a relay, which may use conference call functionality, between the local access device 38 and a telephone associated with the one of the plurality of telephone numbers via the cellular network and a second network is established. Referring to blocks 216 through 220 together, this system and method provide for a plurality of call circuits to be initiated by the management server 12 in response to receiving the access request from the local access device 38. Each of the plurality of call circuits are associated with a telephone number of the owner of the property. In the instance of a connection, a relay call circuit is established by the management server 12 between the local access device 38 and the owner. This relay call circuit is able to accept a command signal, e.g., “grant access” or “no access,” from the owner.

At block 222, upon receipt of a command signal from the telephone at the management server 12, a control signal is transmitted over the wireless network 18 to the local access device 38, which as mentioned is electromechanically coupled to the control unit 34. At block 224, the control signal is received at the local access device 38 and relayed to the control unit 34. In response to receiving the control signal at the control unit 34, at block 226, the moveable structure 30 is actuated from a first position to a second position.

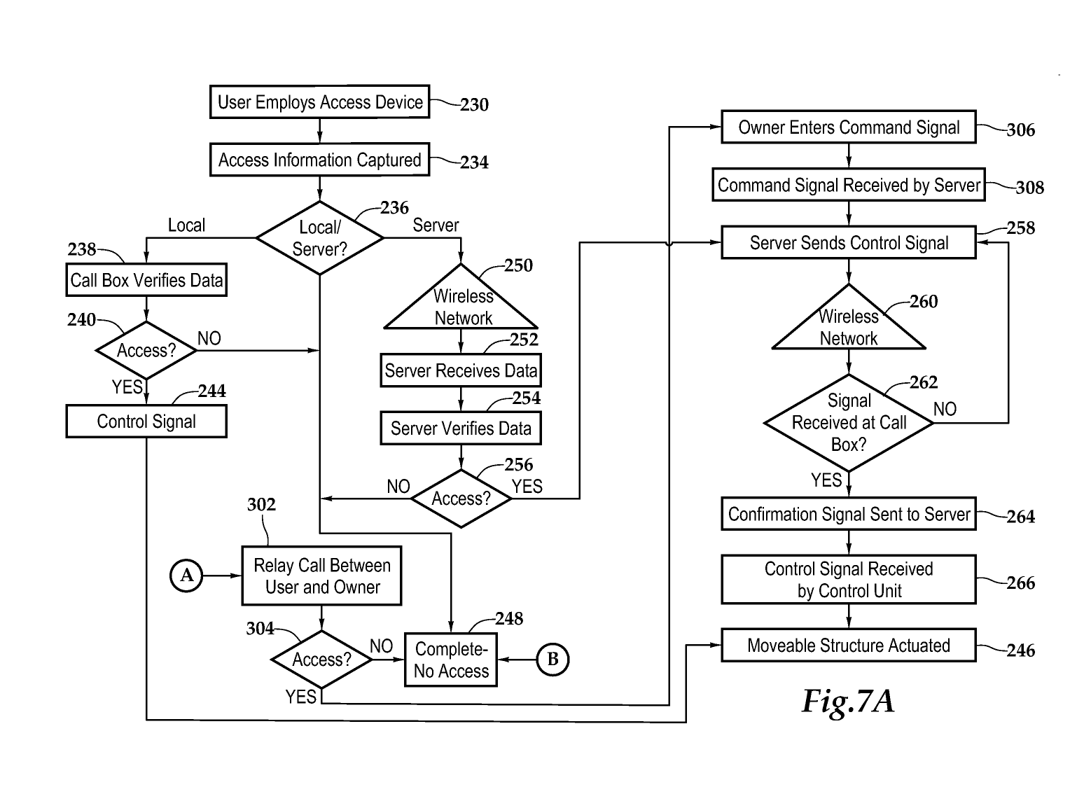

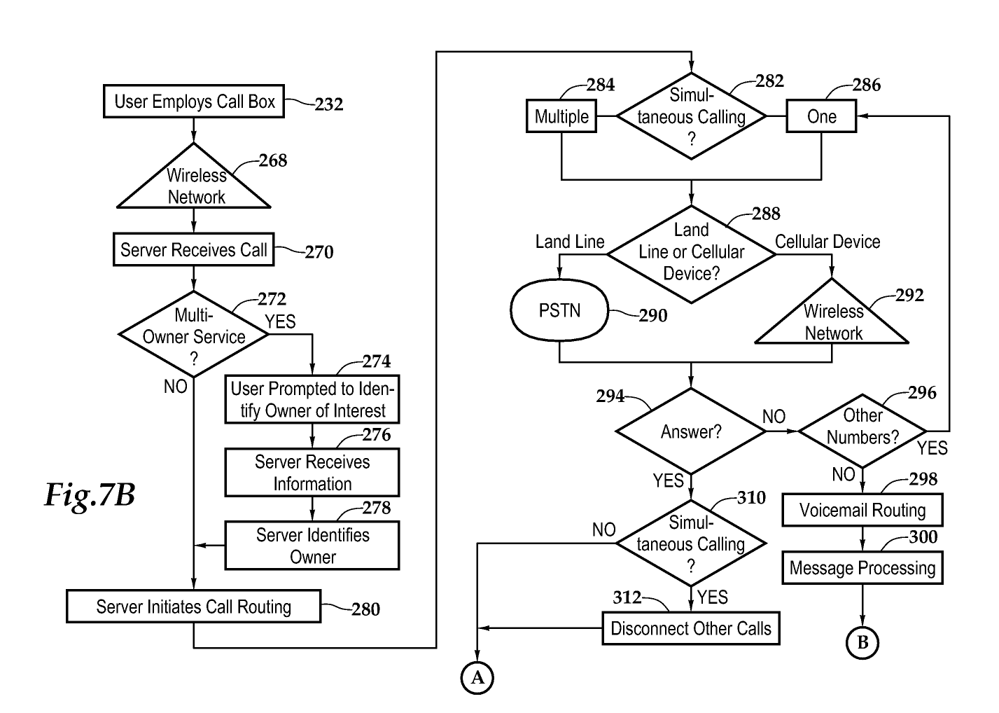

FIGS. 7A and 7B show a further embodiment of a method for wirelessly actuating a moveable structure. Referring to both of these figures, a user may initially use an access device to actuate the moveable structure as shown at block 230 or the user may initially employ the call box functionality of the local access device to call the owner of the property as shown at block 232. Continuing with block 230, once the access device is used, the access information is captured at block 234 by a Wiegand-compatible access device. At decision bock 236, if the access information is locally stored, the methodology continues one way and if the access information is remotely stored, then the methodology continues another way.

In instances where the information is locally stored, the methodology advances to block 238 where the local access device, which may be referred to as a call box, verifies the data with the use of the local access device database. At decision block 240, if access is granted, then a control signal is generated at block 244 and the moveable structure is actuated at block 246. Returning to block 240, if access is denied, then the process is complete at block 248.

Returning to decision block 236, if the access information is stored remotely at the management server, then using the wireless network as shown by numeral 250, the access information is transferred from the local access device to the server at block 252. The data is verified at block 254 and, at decision block 256, if access is denied, then the process is complete at block 248. On the other hand, if verification is positive, then the methodology advances to block 258 where the server sends a control signal to the local access device to provide instructions to actuate the moveable structure. This control signal is sent using the wireless network as indicated by numeral 260. At decision block 262, if the management server believes that the control signal has not been received by the local access device, then the methodology returns to block 258 so that another control signal may be sent.

Otherwise, the methodology advances to block 264 where in one implementation a confirmation signal is sent by the local access device to the management server confirming receipt of the control signal. At block 266, the control signal is forwarded from the local access device to the control unit so that the moveable structure is actuated at block 246.

Returning to block 232, in instances where the user visiting the property does not have an access device or for some reason the access device is not functioning, as mentioned, the user may utilize the call box functionality of the local access device. An access request is sent via the wireless network as shown at block 268 and this access request is received by the management server at block 270. At decision block 272, if the local access device from the access request was received services multiple owners, then the methodology advances to block 274 where the management server prompts the user to identify the owner. For example, a menu may be presented by VRI and the user may be assisted by a sign or directory posted adjacent to the local access device. At block 276, once the server receives the information, the particular property owner of interest is identified at block 278.

The methodology then advances to block 280 where the methodology rejoins with a “NO” to decision block 272. The server initiates the call routing and at decision block 282 if simultaneous calling is enabled and the owner has multiple numbers, then call circuits for multiple numbers are initiated at block 284. Otherwise, a single number call circuit is initiated at block 286. Continuing to decision block 288, for each call circuit being initialized, either a land line as represented by the PSTN block 290 is used or, for example, if the owner has a cellular device, then the wireless network block 292 is employed. At decision block 294, if the calls are not answered and other numbers are available as indicated at decision block 296, then the methodology returns to block 286 to continue calls. If, however, no other numbers are available, then the process continues to block 298 where the call is routed to voicemail and, in one implementation, a message may be taken at block 300. The process is then complete at block 248.

Returning to block 294, if the call is answered by the owner, then as shown at decision block 310 and block 312, any other simultaneously made calls are disconnected. Continuing to block 302, the management server relays the call between the user an the owner. At decision block 304, if the owner does not wish to grant access, then the process is complete at block 248. On the other hand, if the owner wants to grant access then at block 306, the owner enters a command signal, which may be a voice activated signal or button actuated DTMF signal. At block 308, the command signal is received at the server and, then continuing through blocks 258, 260, 262, 264, and 266, which were previously discussed, a control signal is originated from the management server and sent to the local access device to eventually actuate the moveable structure as shown at block 246.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. An interface system for wirelessly actuating a relay associated with a moveable structure located on a property, the interface system comprising:
a control unit associated with the moveable structure, the control unit for actuating the relay from a first state to a second state in response to receiving a first control signal;
a local access device electromechanically coupled to the control unit and disposed in wireless communication with a wireless network, the local access device for receiving a second control signal and forwarding the first control signal to the control unit;
a server disposed in wireless communication with the cellular network, the server in response to receiving and verifying a command signal, for sending the second control signal;
a plurality of call circuits initiated by the server in response to receiving an access request from the local access device, each of the plurality of call circuits associated with a telephone number of the owner of the property; and
a relay call circuit established by the server between the local access device and the owner, the relay call circuit for accepting a command signal from the owner.

2. The system as recited in claim 1, wherein the system further comprises:
a Wiegand-compatible access device connected to the local access device;
a Wiegand interface module coupled to the Wiegand-compatible access device;
a remote access device database located at the server, the remote access device storing access codes;
a local access device database coupled to the Wiegand interface module, the remote access device database periodically updating the local access device database via the wireless network,
wherein in response to receiving an access code at the Wiegand-compatible access device, the Wiegand interface module verifies the access code with the local access device database before issuing the first control signal.

3. The system as recited in claim 2, wherein the Wiegand interface module is an aftermarket addition to an existing local access system.

4. The system as recited in claim 1, wherein the system further comprises:
a Wiegand-compatible access device connected to the local access device;
a Wiegand interface module coupled to the Wiegand-compatible access device; and
a remote access device database located at the server, the remote access device storing access codes,
wherein in response to receiving an access code at the Wiegand-compatible access device, the Wiegand interface module verifies the access code with the remote access device database before issuing the first control signal.

5. The system as recited in claim 4, wherein the Wiegand interface module is an aftermarket addition to an existing local access system.

6. The system as recited in claim 1, further comprising a voice interface module located with the local access device, the voice interface module working in combination with a wireless modem to communicate with the wireless network.

7. The system as recited in claim 1, wherein the moveable structure comprises a structure including one panel which completes a motion in order to at least partially close an entrance selected, the motion selected from the group consisting of being swung, being drawn, being raised, and being lowered.

8. The system as recited in claim 1, wherein the control unit and the local access device are at least partially integrated.

9. The system as recited in claim 1, wherein the first state to the second state corresponds to an open position to a closed position.

10. The system as recited in claim 1, wherein the first state to the second state corresponds to a locked position to an unlocked position.

11. The system as recited in claim 1, wherein the first control signal includes instructions selected from the group consisting of open, hold open, delay open, close, and delay close.

12. The system as recited in claim 1, wherein the owner comprises an individual selected from the group consisting of a resident, a guest, a designated party, and security personnel.

13. The system as recited in claim 1, wherein the wireless network is selected from the group consisting of cellular networks, the Internet, satellite networks, paging, and combinations thereof.

14. The system as recited in claim 1, wherein the plurality of call circuits comprise networks selected from the group consisting of cellular networks, the Internet, paging, satellite networks, and combinations thereof.

15. The system as recited in claim 1, wherein the first control signal and second control signal comprise different signals.

16. The system as recited in claim 1, wherein the first control signal and the second control signal comprise identical signals.

17. A method for wirelessly actuating a relay associated with a moveable structure located on a property, the method comprising:
accepting an access code at a local access device from a Wiegand-compatible access device, the local access device being electromechanically coupled to a control unit and disposed in wireless communication with a wireless network;
transmitting the access code over the wireless network from a Wiegand interface module to a server, the Wiegand interface module being disposed in communication with the Wiegand-compatible access device;
receiving the access code at the server;
verifying the access code at the server by referencing a remote access device database located at the server, the remote access device storing access codes;
upon verification, transmitting a control signal over the wireless network to the local access device;
receiving the control signal at the local access device and relaying the control signal to the control unit; and
in response to receiving the control signal at the control unit, actuating the relay, thereby actuating the moveable structure from a first position to a second position.

18. The method as recited in claim 17, further comprising selecting a Wiegand-compatible access device from the devices consisting of keycard readers, proximity readers, and keypads.

19. A method for wirelessly actuating a relay associated with a moveable structure located on a property, the method comprising:
periodically transmitting access codes over a wireless network from a server to a Wiegand interface module, the Wiegand interface module being disposed in communication with a Wiegand-compatible access device at a local access device electromechanically coupled to a control unit;
storing the access codes at a local access device database located with the local access device;
accepting an access code at a local access device from the Wiegand-compatible access device;
verifying the access code by referencing the local access device database located at the local access device;
upon verification, sending a control signal to the control unit; and
in response to receiving the control signal at the control unit, actuating the relay, thereby actuating the moveable structure from a first position to a second position.

20. The method as recited in claim 19, further comprising selecting a Wiegand-compatible access device from the devices consisting of keycard readers, proximity readers, and keypads.

21. A method for wirelessly actuating a relay associated with a moveable structure located on a property, the method comprising:
accepting an access code at a local access device from a Wiegand-compatible access device, the local access device being electromechanically coupled to a control unit and disposed in wireless communication with a wireless network;
transmitting the access code over the wireless network from a Wiegand interface module to a server, the Wiegand interface module being disposed in communication with the Wiegand-compatible access device;
receiving the access code at the server;
utilizing a Wiegand output device to connect the server to a legacy third-party control panel;
verifying the access code at the legacy third-party control panel;
upon verification, returning a control signal to the server;
transmitting the control signal over the wireless network to the local access device;
receiving the control signal at the local access device and relaying the control signal to the control unit; and
in response to receiving the control signal at the control unit, actuating the relay, thereby actuating the moveable structure from a first position to a second position.

22. The method as recited in claim 21, further comprising selecting a Wiegand-compatible access device from the devices consisting of keycard readers, proximity readers, and keypads.
